(19) United States
(12) Patent Application Publication
(10) Pub. No.: US 2003/0102967 A1
(43) Pub. Date: Jun. 5, 2003

(54) Wireless solar energy burglar-proof device

(76) Inventor: Eric Kao, Kweishan (TW)

Correspondence Address: BIRCH STEWART KOLASCH & BIRCH, PO BOX 747, FALLS CHURCH, VA, 22040-0747, US

(21) Appl. No.: 09/996,983

(22) Filed: Nov. 30, 2001

(51) Int. Cl. G08B 19/00

(52) U.S. Cl. 340/521; 340/693.5; 340/539.1

(57) ABSTRACT

A wireless solar energy burglar-proof device has a power source from the nature source. The wireless solar energy burglar-proof device includes an energy capturing device, a battery, an electric heating detector, a microprocessor, a transmission device, a wireless receiving device, an alarming device, and a CCTV device. The electric heating detector and other external detectors are responsible for monitoring a detecting area. When a trigger signal occurs, the microprocessor will be triggered so that the microprocessor will enter into a working condition. Then, the microprocessor drives the CCTV device and the transmission device. Then the signal is transferred to the receiver end or a control center in a high frequency way for real-time monitoring and recording an image so as to monitoring an area, recording signals or actuating the alarming device for preventing the intrusion of burglar. At the power is Insufficient, the battery will provide the power required in the present invention so as to become an uninterrupted device. When the power of the battery is insufficient. The microprocessor will emit a signal to inform other people to take attention to what occurs in the area.

### FIELD OF THE INVENTION

The present invention relates to a wireless solar energy burglarproof device with a natural energy source.

### BACKGROUND OF THE INVENTION

The safety of houses catches more and more attentions recently since everyone wants a safe and comfortable environment which is not intrude by other people. In the past, human kept safety of a house by locking. However, since nowadays, for wisdom burglars, locks are nothing important for preventing them from entering into a house, many tools and technologies are helpful for them to destroy a door lock.

Thus, many burglar-proof devices are developed, In general, these burglar-proof devices have sensors which are connected to a mainframe by wires. In one aspect, the mainframe may provide power, another; it may be used to trigger an alarm or others. While, the installation of the wires is a complex work which will destroy the original environment. Further, the supply of electric power is another problem, since it is possible that the power supply is interrupted. However, natural power is a trend recently, many devices acquire power from natural source, such as wind power, water power or solar energy.

### SUMMARY OF THE INVENTION

Accordingly, the primary object of the present invention is to provide a wireless solar energy burglar-proof device, where nature energy is used as a power source of the present invention, not only power is saved, but also resource can be used effectively.

Another object of the present invention is to provide a wireless solar energy burglar-proof device which can be installed easily without any other tool.

A further object of the present invention is to provide a wireless solar energy burglar-proof device, wherein a plurality of the wireless solar energy burglar-proof devices can be installed in a predetermined so as to provide more safety in the life. The data captured is transferred to the mainframe, receiver, or other wireless devices, such as a mobile phone, a personal digital assistant (PDA), etc. as a secondary monitoring system.

To achieve above objects, the present invention provides a wireless solar energy burglar-proof device having a power source form the nature source. The wireless solar energy burglar-proof device includes an energy capturing device, a battery, an electric heating detector, a microprocessor, a transmission device, a wireless receiving device, an alarming device, and a CCTV device. The electric heating detector and other external detectors are responsible for monitoring a detecting area. When a trigger signal occurs, the microprocessor will be triggered so that the microprocessor will enter into a working condition. Then, the microprocessor drives the CCTV device and the transmission device. Then the signal is transferred to the receiver end or a control center in a high frequency way for real-time monitoring and recording an image so as to monitoring, recording or actuating the alarming device for preventing the intrusion of burglar. At the power is insufficient, the battery will provide the power required in the present invention so as to become an uninterrupted device. When the power of the battery is insufficient. The microprocessor will emit a signal to inform other people to take attention to what occurs in the area.

The various objects and advantages of the present invention will be more readily understood from the following detailed description when read in conjunction with the appended drawing.

### BRIEF DESCRIPTION OF THE DRAWINGS

FIG. 1 is a perspective view of the wireless solar energy burglarproof device according to the present invention;

FIG. 2 is a lateral perspective view of the wireless solar energy burglar-proof device in the present invention; and

FIG. 3 shows the block diagram of the internal structure in wireless solar energy burglar-proof device of the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

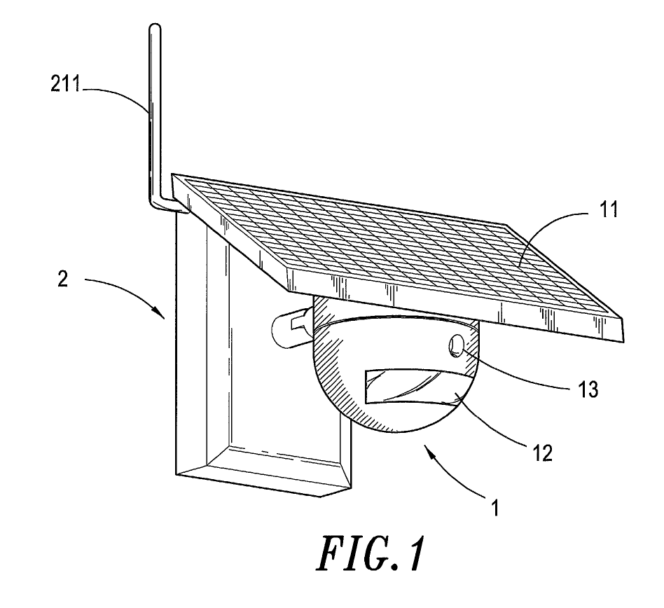

Referring to FIG. 1, the wireless solar energy burglar-proof device of the present invention is illustrated therein. The wireless solar energy burglar-proof device includes a detecting box body 1 which is a box for enclosing other device. An energy-capturing device 11 is installed out of the box for absorbing light. The light is converted into electric power through an energy conversion device, the power may charge a battery at any time. The energy-capturing device 11 has a slope so that the area for absorbing light is wider. An electric heating detector 12 is responsible for monitoring the safety of an area. The detecting area is wide. A microprocessor is used to give an actuation signal. A CCTV device 13 receives an actuation signal from the microprocessor and is responsible for recording an image capturing area. Then, the data signal is transferred to a transmission device for being emitted to a receiver end through a wireless signal. A control box body 2 is a box which other devices are included therein. An antenna 221 of the transmission device 21 is installed out of the box.

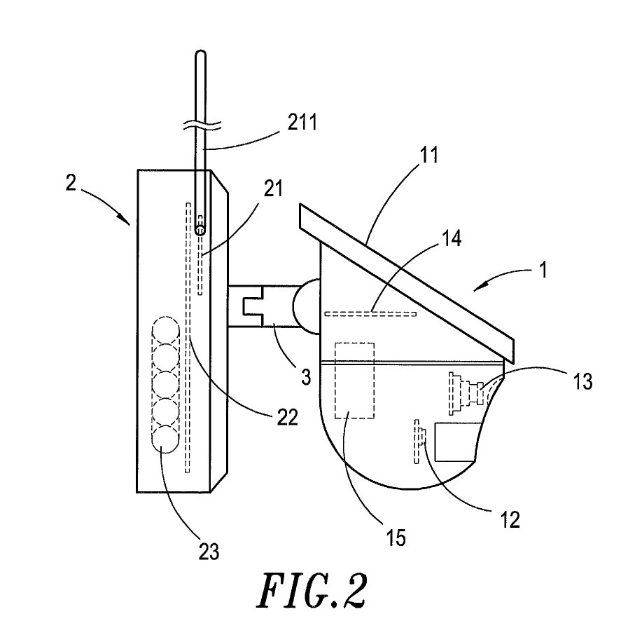

The interior of the box has a microprocessor 22 and a battery 23 (referring to FIG. 2).

With reference to FIG. 2, a lateral perspective view of the present invention is illustrated. A joint 3 is installed between the detecting box body 1 and the control box body 2. The joint 3 can be adjusted leftwards, rightwards, upwards and downwards so that the present invention may monitor an area in all aspects.

The interior of the detecting box body 1 has a wireless receiving device 14 which is responsible for receiving the wireless signals from the detecting objects of such as doors, windows, smokes, or others. Further, the microprocessor 22 serves to trigger an alarming device 15.

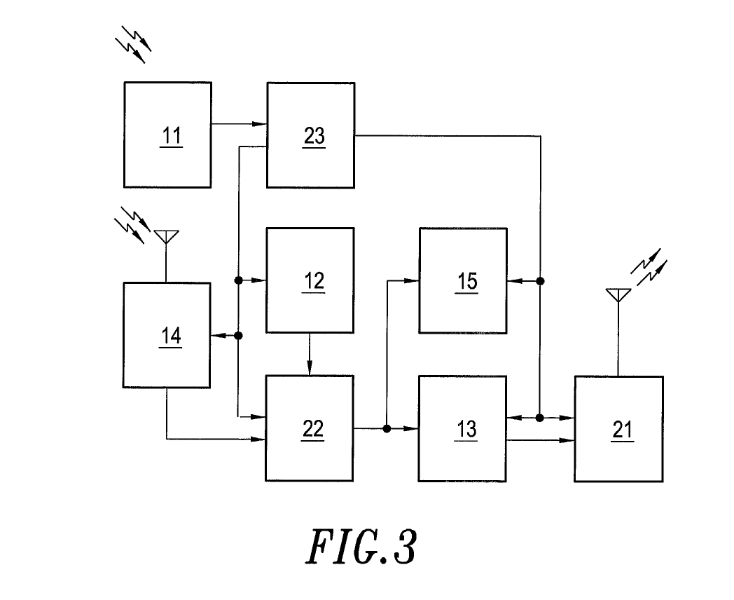

With reference to FIG. 3, a block diagram of the inner devices of the present invention is illustrated. The energy-capturing device 11 is primarily used to receive light energy, primarily of solar energy. The light energy is converted into electric energy through an energy conversion device as the power of the present invention. Meanwhile, the energy-capturing device 11 serves to store surplus energy as the power the battery 23. Normally, the CCTV device 13 and the transmission device 21 are in a stand-by condition without consuming any power. When the area detected by the electric heating detector 12 generates a trigger signal due to intrusion of other object. The electric heating detector 12 will trigger a microprocessor 22 so as the microprocessor 22 enters into a working condition. Then, the microprocessor 22 drives the CCTV device 13 and the transmission device 21 so that real-time image is transmitted by high frequency through the transmission device 21. The the signal is transferred to the receiver end or a control center for real-time monitoring and recording an image.

At cloudy whether or as light is insufficient, the battery 23 will provide the power required in the present invention so as to become an uninterrupted device. When the power of the battery 23 is insufficient. The microprocessor 22 will emit a signal to inform other people to take attention to what occurs in the area, or lights of other colors may be emitted from a light emitting diode at the exterior of the housing.

In the burglar-proof area, a plurality of wireless solar energy burglar-proof device may be installed and a plurality of wireless doors, windows, smokes or human bodies detecting devices so as to become a dense protecting system. The various burglar-proof devices can be numbered. In the mainframe or the monitoring chamber, from the number, the area being intruded can be decided so that the operations of monitoring, acknowledging and expelling can be executed.

The wireless solar energy burglar-proof device of the present invention has the following advantages:

1. As the present invention is installed outdoors, no wiring working is necessary.

2. The position for installing the present invention can be changed in the detecting range so that the burglar can not found any critical points for intrusion.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wireless solar energy burglar-proof device comprising:
an energy capturing device having a capturing end installed at an outer side of a casing, absorbing light being converted into electric power through an energy conversion device, the power being charged to a battery;
an electric heating detector being connected to a microprocessor for performing instructions from the microprocessor, and monitoring an wide area for safety;
a microprocessor responsible for receiving instructions from the electric heating detector, and driving an CCTV device and a transmission device;
a transmission device for transferring audio and video signals of high frequency captured by the CCTV device;
a wireless receiving device for receiving detected signals of doors, windows, smokes, objects from a burglar-proof detector;
an alarming device; and
a battery;
wherein by combination of above devices, the electric heating detector and other external detectors are responsible for monitoring a detecting area; when a trigger signal occurs, the microprocessor will be triggered so that the microprocessor will enter into a working condition; then, the microprocessor drives the CCTV device and the transmission device; then the signal is transferred to the receiver end or a control center in a high frequency way for real-time monitoring and recording an image so as to monitoring the area, recording signals or actuating the alarming device for preventing the intrusion of burglars.

2. The wireless solar energy burglar-proof device as claimed in claim 1, wherein the energy conversion device, electric heating detector, and CCTV device are installed out of the casing.

3. The wireless solar energy burglar-proof device as claimed in claim 1, wherein a joint is installed between the detecting box body and the control box body; the joint is adjusted leftwards, rightwards, upwards and downwards so as to monitor an area in all aspects.

4. The wireless solar energy burglar-proof device as claimed in claim 1, wherein the energy capturing device has a slope so that the area for absorbing light is wider.
